(19) United States
(12) Patent Application Publication
(10) Pub. No.: US 2013/0108458 A1
(43) Pub. Date: May 2, 2013

(54) VERTICAL AXIS WIND TURBINE WITH SOFT AIRFOIL SAILS

(71) Applicant: Leonid Goldstein, Los Angeles, CA (US)

(72) Inventor: Leonid Goldstein, Los Angeles, CA (US)

(21) Appl. No.: 13/284,953

(22) Filed: Oct. 30, 2011

(51) Int. Cl. F03D 3/06

(52) U.S. Cl. 416/240

(57) ABSTRACT

One embodiment of vertical axis wind turbine, having a soft sail (101), receiving airfoil form in the relative air flow. The soft sail (101) is attached to a mast (102), connected to a rotating shaft (202), transferring motion to a generator or alternator (203). Another embodiment of vertical axis wind turbine, having a soft sail (1306), receiving its airfoil form from the relative air flow and centrifugal forces, acting on it. Other embodiments are described and shown.

### BACKGROUND OF THE INVENTION

Wind driven devices for pumping water and grinding grains are known to humanity for at least 2,000 years. Today, they are widely used for generating electricity. Two main classes of the wind turbines are horizontal axis wind turbines (HAWT) and vertical axis wind turbine (VAWT). Wind turbines can be also classified by how they harvest the energy of the wind. Two main classes are those that use mostly aerodynamic drag, and those that use mostly aerodynamic lift. The lift based turbines are much more efficient than drag based, having theoretical maximum coefficient of power 59% versus 18% for drag based devices. Lift based VAWTs are more relevant to this invention. The state of the art in the lift based VAWTs is represented by Darrieus H-rotor, Darrieus phi-rotor (“egg-beater”) and Gorlov (helical) designs, and their derivatives. Also, Cycloturbine deserves to be mentioned, although it is not widely used. Description of these designs can be easily found on Wikipedia. Also, U.S. Publication Ser. No. 12/382,305 provides a good description of the prior art in its background section.

The main shortcoming of the VAWTs (as well as HAWTs and most other ‘alternative’ energy sources) is high initial expense per kilowatt-hour of generated energy. Specific disadvantage of the lift based VAWTs is also narrow range of wind speeds, in which they can work.

Additional shortcoming of the Darrieus H-rotor is large and variable lateral forces, acting on the rotor. They make necessary heavy horizontal bar, and are known to cause fatigue failure of the rotor. Also, it cannot self start.

The Phi-rotor solves the problem, but at the expense of much more complex and expensive blade, smaller covered area for the same height and width and absence of aerodynamic control (especially braking) of the blade.

Cycloturbine is too complex and even more expensive.

Some embodiments of this invention draw on the existing art in the sailboat sails and rigging as well.

### BRIEF SUMMARY OF THE INVENTION

In accordance with one embodiment, a vertical axis wind turbine has a soft sail, receiving its airfoil form in the relative air flow. In accordance with another embodiment, a vertical axis wind turbine has a soft sail, receiving its airfoil form from the relative air flow and centrifugal forces, acting on the sail.

Several advantages of one or more aspects are as follows. Less expensive per kilowatt-hour vertical axis wind turbine (VAWT). VAWT, easier to deliver and install. Safer and better controllable VAWT. VAWT, capable to work in wider range of wind speeds. VAWT, safer for birds.

Other advantages of one or more aspects will be apparent from a consideration of the drawings and ensuing description.

### LIST OF THE DRAWINGS

FIG. 1 shows a sail assembly according to one embodiment of the invention

FIG. 2A shows a wind turbine with one mast according to one embodiment of the invention

FIG. 2B is a top view of the same embodiment of the invention

FIG. 3 is a schematic view of the soft sail in different positions relative to the wind in the same embodiment of the invention

FIG. 4 shows a sail assembly according to another embodiment of the invention

FIG. 5 shows a wind turbine with one mast according to another embodiment of the invention

FIG. 6 shows a sail assembly according to one more embodiment of the invention

FIG. 7 is a top view of the wind turbine according to one more embodiment of the invention

FIG. 8 is a schematic view of the soft sail in different positions relative to the wind in the same embodiment of the invention

FIG. 9 shows a sail assembly according to one more embodiment of the invention

FIG. 10A shows a wind turbine with one mast according to one more embodiment of the invention

FIG. 10B is a top view of one the same embodiment of the invention with two masts

FIG. 11A shows a wind turbine with one mast according to one more embodiment of the invention

FIG. 11B is a top view of the same embodiment of the invention

FIG. 12A shows examples of the sail forms

FIG. 12B shows example of a sail assembly according to another embodiment

FIG. 13A shows a wind turbine according to one more embodiment of the invention

FIG. 13B is a top view of the same embodiment

FIG. 13C is a top sectional view of the sail in the same embodiment

FIG. 13D is a top view of a separated sail assembly according to the same embodiment

FIG. 14 shows a wind turbine according to one more embodiment of the invention

FIG. 15 shows a wind turbine according to one more embodiment of the invention

FIG. 16A shows a wind turbine according to one more embodiment of the invention

FIG. 16B is a top view of the same embodiment of the invention

Some pictures omit details and show parts out of proportion for clarity.

### DETAILED DESCRIPTION OF THE INVENTION

Some embodiments of the invention present a vertical axis wind turbine for producing electrical energy, having a soft (flexible, fabric, or cloth) sail. Some embodiments of the invention are soft sail assemblies, suitable for use in vertical axis wind turbine. Some embodiments comprise soft sail that receives airfoil form from relative air flow. Here, ‘airfoil’ means a form, providing substantial aerodynamic lift. In some embodiments, the soft sail receives airfoil form from combination of relative air flow and centrifugal forces. The embodiments of the invention further comprise substantially vertical rotating shaft, horizontal arms, connected to the shaft, non-rotating base and electrical generator or alternator, driven by the rotating shaft. Some embodiments use a rigid mast and a cantilever, perpendicularly connected to this mast to support the sail. Some embodiments have the mast rigidly connected to the horizontal arms, and some embodiments use cables to connect the sail assembly to the horizontal arms and transfer forces from the sail to the rotating shaft. Some embodiments use flexible cables to transfer forces from the sail to the shaft. Some embodiments use flexible cables to support the sail in the motion. Some embodiments have the sail, spread on the cables in the form of troposkein. Some embodiments further contain means to control up to three main parameters of the airfoil, created by the sail (airfoil length, airfoil thickness and angle of attack) and a control system, managing these controlling means.

Various embodiments of the invention are shown with reference to the figures. The figures show the embodiments of the invention with the wind from the left and clockwise rotation of the central shaft, when viewed from above, unless described differently.

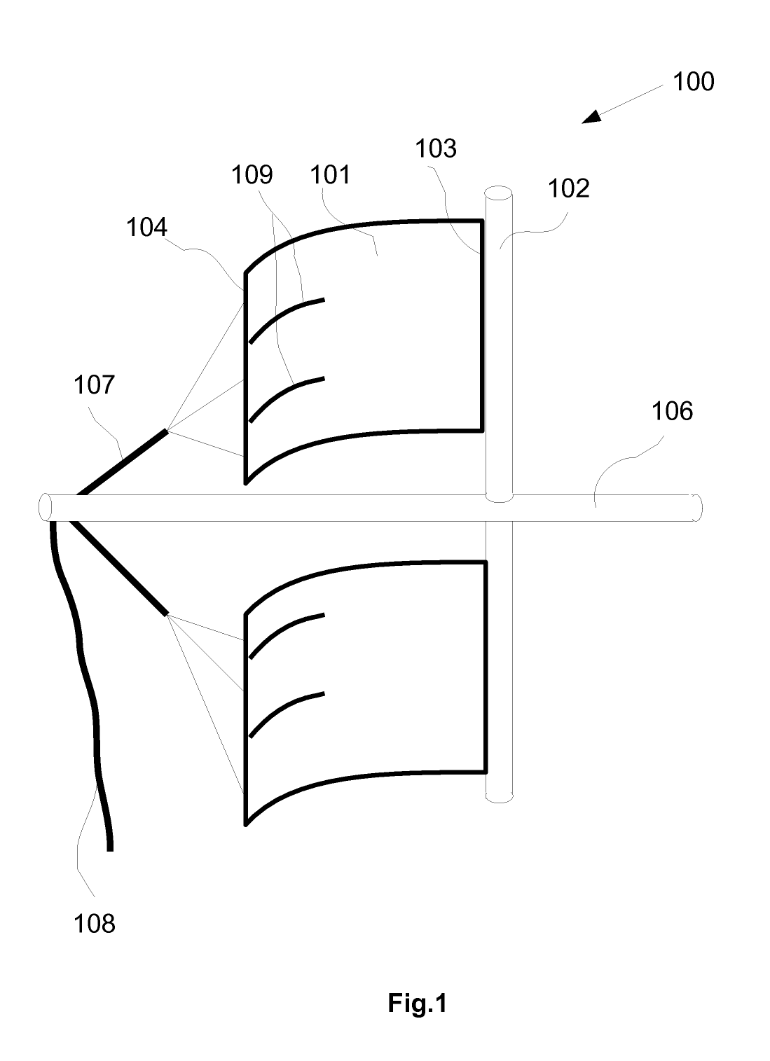

FIG. 1 shows a sail assembly 100, according to one embodiment of the invention. A soft sail 101 is attached to a mast 102 with its leading edge 103. The opposite from the leading is a trailing edge 104. The trailing edge 104 can be reinforced with a steel wire. A boom 106 is attached to mast 102 in such a way that the boom can rotate 180 degrees around it. An outhaul cable 107 connects the free end of boom 106 and trailing edge 104 of sail 101. A main sheet cable 108 is attached to the end of the boom to limit its movement under the force of the relative air flow and the centrifugal force. Boom 106 is extended past mast 102 in order to provide weight and centrifugal force balance. The sail has optional battens 109, reinforcing the sail. Air flow, relative to sail 101, gives the sail airfoil form (i.e. a form that provides substantial aerodynamic lift).

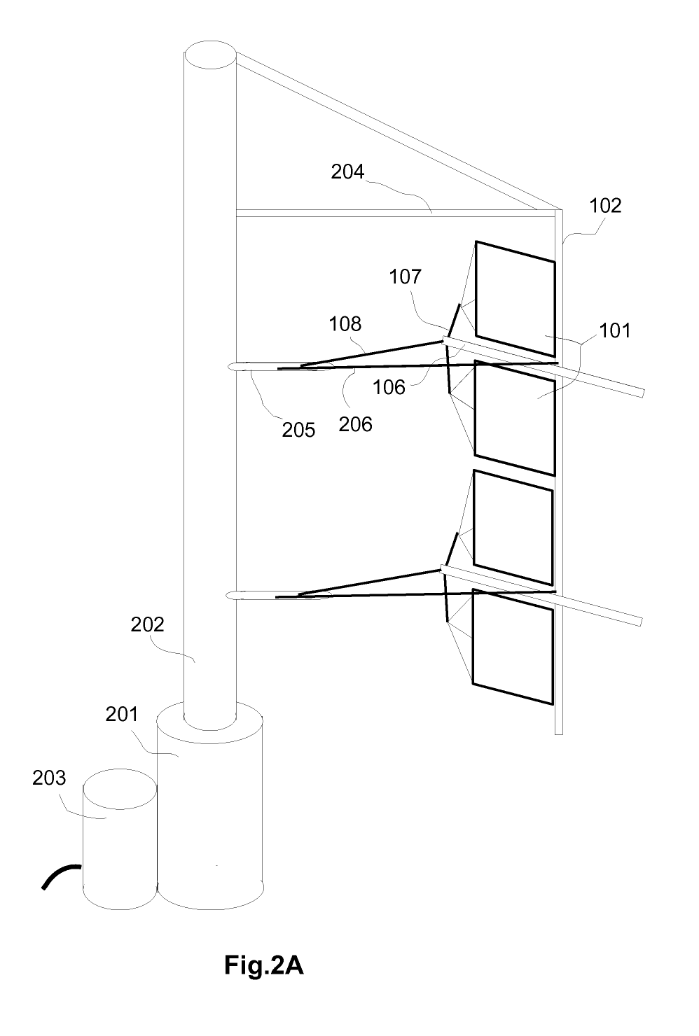

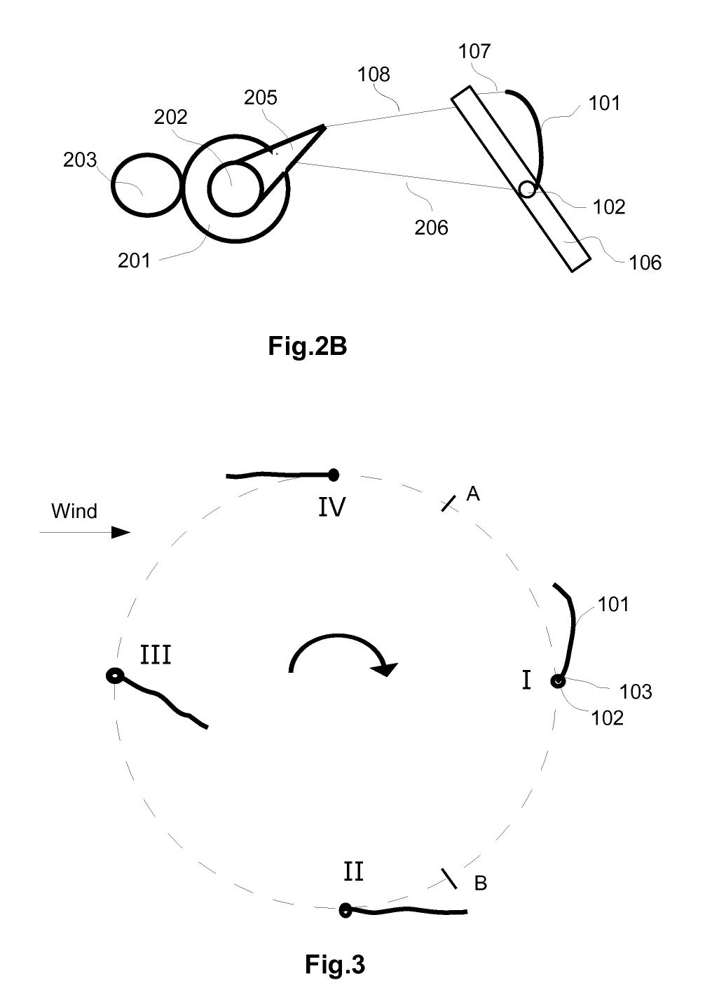

FIG. 2A and FIG. 2B show a vertical axis wind turbine according to one embodiment of the invention, using sail assembly 100. The wind turbine comprises a fixed base 201. A rotating shaft 202 is attached to base 201 in such a way that it can freely rotate on it. Rotation of shaft 202 is transferred to the rotor of a generator or an alternator 203, which generates electricity. One or more cantilevers 204 are attached to shaft 202 (not shown on FIG. 2B for clarity). Each cantilever 204 holds mast 102. One or more sail assemblies 100, described on FIG. 1, are mounted on each mast 102. Each sail assembly comprises sail 101 and boom 106. One or more fixed arms 205 are attached to shaft 202, and each main sheet cable 108 is attached to some arm 205. Each mast 102 is attached to some arm 205 with at least one cable 206 (not visible on FIG. 2A).

In another variation of this embodiment, boom 106 is attached to mast 102 without ability to rotate substantially, while the mast 102 is attached to cantilever 204 with ability to rotate around its own vertical axis.

The rotating shaft together with the sail assemblies, attached to it, is called a turbine rotor. In the presence of the wind, the sails on the leeward side of the rotor become airfoils. When the turbine rotor rotates, aerodynamic lift forces act on the leeward sails. Cables 108 and 206 resist the radial component of the lift and the centrifugal forces, acting on the sail, while transferring tangential component of the lift to the arms 205. The arms 205 rotate shaft 202 which drives the rotor of generator 203 (usually through a gearbox), which produces electricity. Cantilever 204 supports the mast when the turbine rotor does not rotate.

FIG. 3 shows the single sail in different positions, as it rotates in the wind. The round arrow in the middle shows the direction of rotation (clockwise). In the position I, the sail has its airfoil form, sail assembly is powered, and transfers the force of the wind to shaft 202 via cables 108 and 206. In the positions II, III and IV, the sail becomes flat and limp (unpowered) and the assembly is in the neutral position in the relative air stream, overcoming only small resistance of the air, acting on mast 102. Mast 102 is held in its place by cantilever 204 and the centrifugal forces, acting on the sail assembly. The energy is harvested only from the leeward arc of 120-150 degrees (between the points A and B on the picture).

It is contemplated, that this embodiment will optimally have 5-7 masts, equally spaced. Other numbers are possible. As a material for the sails, this embodiment can use para-aramid (for its strength) or polyester (for the combination of strength, elasticity and affordability). As the material for the sails the booms and the mast, this embodiment can use carbon fiber, fiberglass or aluminum. Other materials for the sails, booms and masts are suitable.

The soft sail, described above, can be used as a replacement for rigid wings in most types of the VAWTs with diameter above 2 meters. Sail assemblies, built according to the embodiments described here, will be most effective at the tip speeds below 40 m/s and tip speed ratios below 5.0.

Generally, compared with the rigid wings, used in the wind turbines today, the soft sails described here provide the following advantages:
lower weight due to lower weight of the sail material compared with aluminum or fiberglass, typically used in the modern turbines
lower cost of the sail material of the same area and strength compared with the rigid wings
ability to continuously control the shape, size and orientation of the soft sail
ability to instantly “depower” the soft sail by releasing its trailing edge to prevent damage by excessive winds
in case of breakage, the soft sail is much less dangerous, than a rigid wing
soft sail turbine is less expensive to transport and install
the soft sail is less damaging to birds, hitting it

The VAWT embodiment, described above, can also be placed more densely in the wind farms, compared with conventional VAWTs, because it harvests wind energy only from a leeward arc, rather than from the full circle.

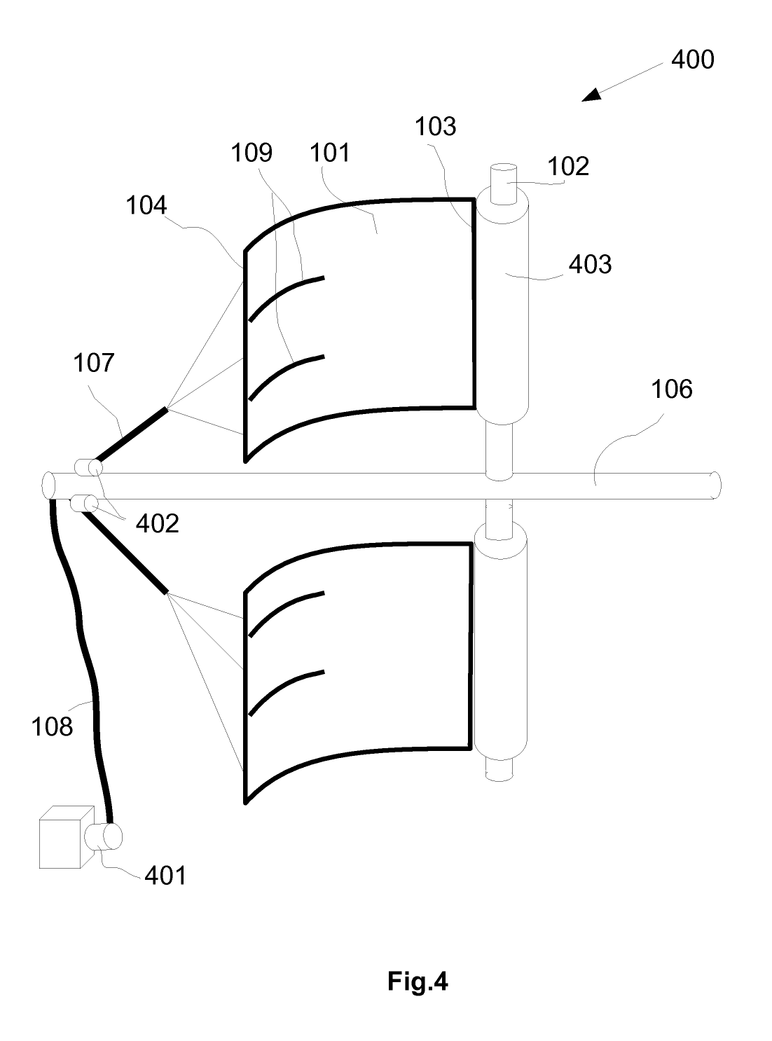

FIG. 4 shows a sail assembly 400, according to another embodiment of the invention. It is similar to the embodiment, shown in FIG. 1, but additionally has one or more of the following elements: an actuator 401 for controlling (pulling and letting out) main sheet cable 108; actuator 402 for controlling (pulling and letting out) outhaul cable 107; furling actuator 403 for furling and unfurling sail 101. Actuator 401 might comprise a small electrical engine, pulling and letting out cable 108, or it might comprise a block, through which cable 108 is attached to an electrical engine, controlling multiple actuators. Control means with actuator 402 might comprise a small electrical engine, pulling and releasing the cable 107. The furling means with actuator 403 might comprise a small electrical engine, furling sail 101 around mast 102, or letting it to unfurl under the pull of outhaul cable 107 and the air flow. Alternatively, it might comprise a block and a cable, leading to an electrical engine, attached to the shaft.

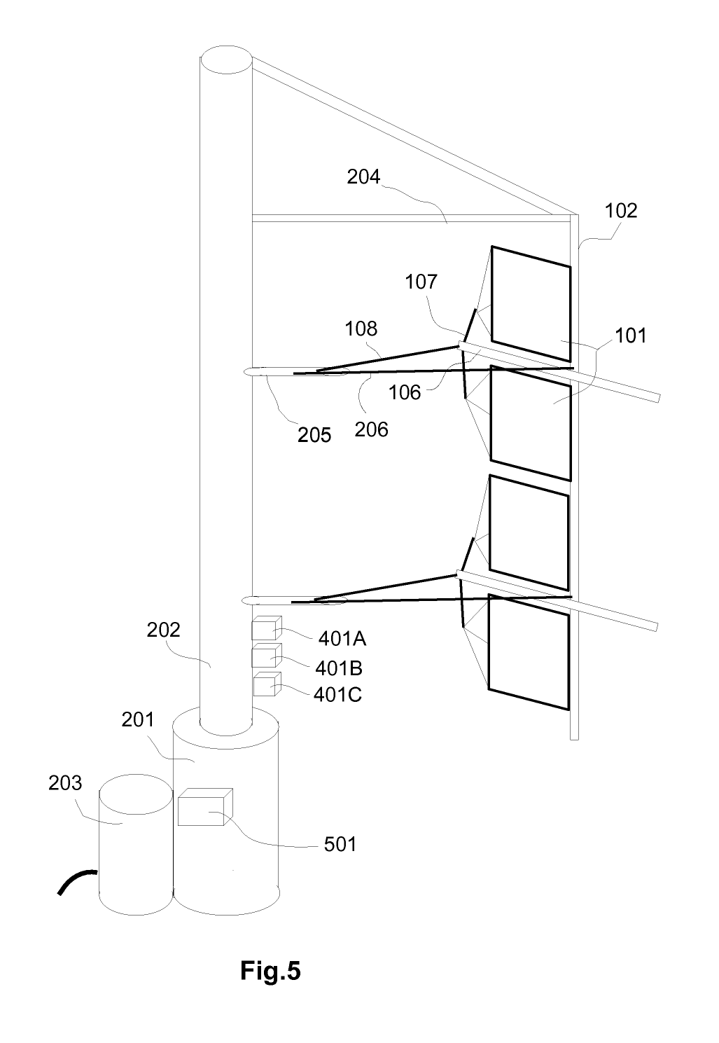

FIG. 5 shows a vertical axis wind turbine according to another embodiment of the invention, using sail assembly 400. It is similar to the embodiment, shown in FIGS. 2A and 2B. Additionally, it contains a control system 501, managing actuator 401, actuator 402 and furling actuator 403. Optionally, actuators 401, 402 and 403 are driven by small electrical engines 401A, 402A and 403A (correspondingly) via additional cables (the additional cables are not shown for clarity).

Usually, control system 501 should include an electronic computer and sensors. Examples of the sensors are: wind direction sensor, wind velocity sensor, sail stall sensor, vibration sensor, cable tension sensor, mast position sensor. But that is not necessary. For example, a simple device, fully releasing the outhaul cable when its tension exceeds some pre-defined value, will be sufficient to protect the device in cases of excessively strong winds.

This embodiment allows controlling all the main parameters of the airfoil, created by sail 101:
the airfoil's length is controlled by furling/unfurling the sail, using the furling means, comprising actuator 403
the airfoil's angle of attack is controlled by the control means, comprising actuator 401
the airfoil's effective thickness is controlled by the control means, comprising actuator 402

Further, the number of airfoils can be controlled by completely furling or unfurling some of the sails. Control system 501 shall apply some or all of the following control methods:

Slow controls (can be applied few times per hour):
a) if there is a forecast of winds, stronger than a pre-determined threshold—fully furl all sails
b) if an airfoil is damaged—fully furl the damaged airfoil
c) fully furl the airfoil on command before it is being serviced
d) partially furl the airfoil if the produced power has reached nominal maximum, and the winds are getting stronger
e) fully furl some airfoils if the produced power has reached nominal maximum, and the winds are getting stronger

Fast controls (applied continuously or frequently):
a) keep the optimal angle of attack, as the sail goes through the energy harvesting arc by pulling main sheet cable 108 using actuator 401 as the angle of the relative air flow decreases
b) if the airfoil is about to stall: pull main sheet cable 108 using actuator 401
c) to decrease forces, acting on the turbine in a gust or strong winds: let out main sheet cable 108 using the actuator 401 (“spill the wind”)
d) to stop the turbine in the dangerous condition or for maintenance (full brake): completely release main sheet cable 108 using actuator 401
e) to increase the forces, acting on the turbine in the weak winds: increase the airfoil thickness by letting out outhaul cable 107 using actuator 402

Other control methods are possible as well. Different sails can be controlled differently, reflecting difference in the wind depending on the height, different wear of the sails, possibly different dimensions of the sails and other factors. Furling actuator 403 shall be used only with types of sail that are not damaged from furling/unfurling. In many variations of this embodiment, all three actuators are not required, and it will be sufficient to have any one or two of them.

This embodiment has an additional advantage of producing near maximum power in the wide range of the winds, from very weak to very strong. This overcomes the main problem of the wind power (and especially VAWT)—its unstable power output. It is also more resilient for damage and wear.

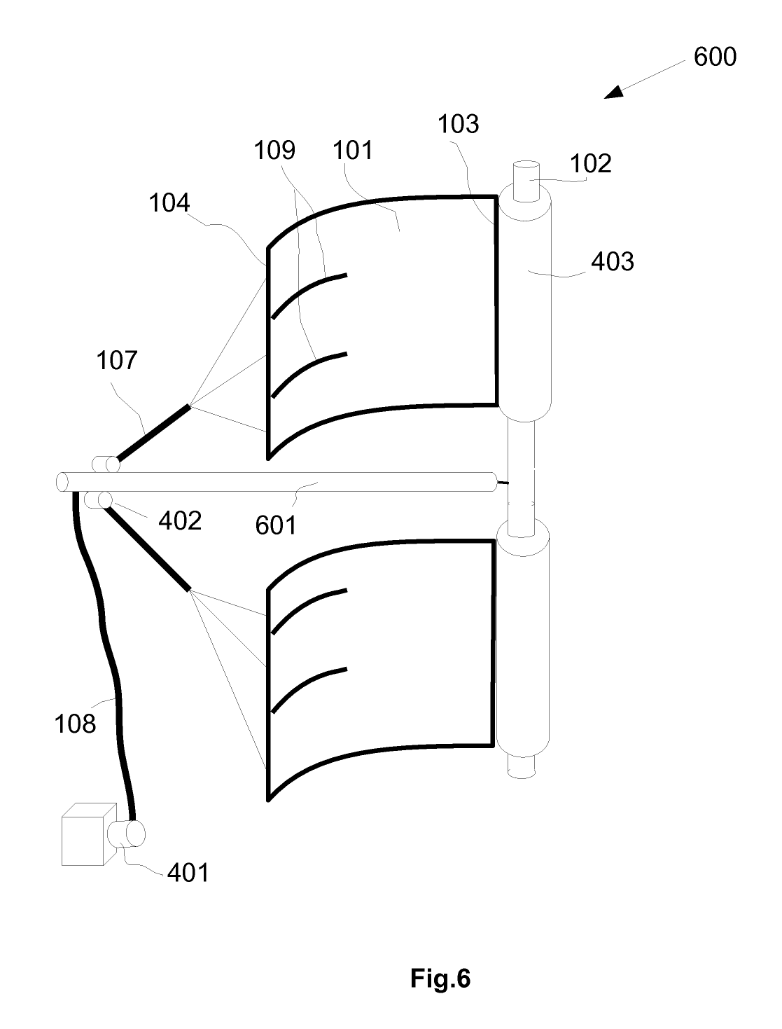

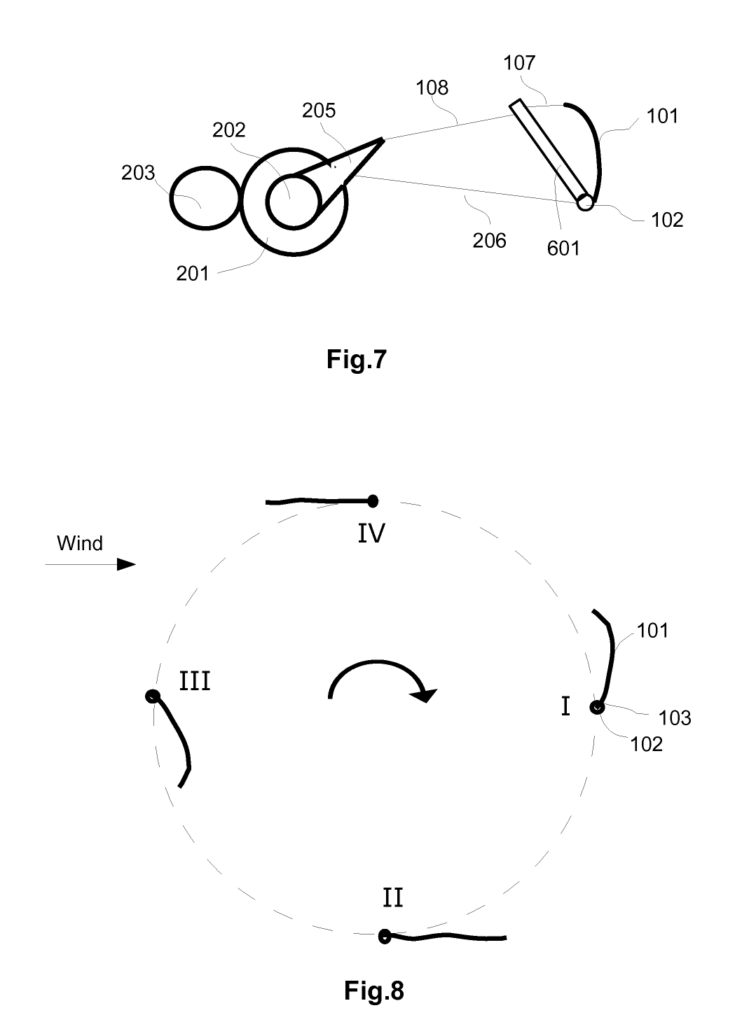

FIG. 6 shows a sail assembly 600, according to another embodiment of the invention. It is similar to the sail assembly 400, but instead of the balanced boom 106 it has an unbalanced boom 601. FIG. 7 shows top view of this embodiment. Otherwise, it is similar to the embodiment, depicted on FIG. 5. As shown on FIG. 8, the sail assembly in this embodiment harvests wind power over all the circle of rotation, except for the positions II and IV and their vicinity. In the position III, the centrifugal force pushes the boom 601 (not shown) and the sail 102 away from the shaft, and the sail receives its airfoil form and the tangential component of the lift force, acting on it, is transferred to the shaft. This embodiment will optimally have 2-3 masts with the sails. This embodiment works best for smaller diameter (2 m-40 m) wind turbines, in which centrifugal forces, acting on the sail assembly, can compensate the force of the wind. The control means work similarly to the embodiment from FIG. 4, except that action of the main sheet cable actuator has opposite effect in the leeward and windward arcs (pulling the main sheet cable 108 increases the angle of attack on the leeward side, but decreases it on the windward side).

Another embodiment is obtained by using the boom 601 from FIG. 6 with the sail assembly from FIG. 1 and the wind turbine from FIGS. 2A and 2B (i.e., by deleting the control means).

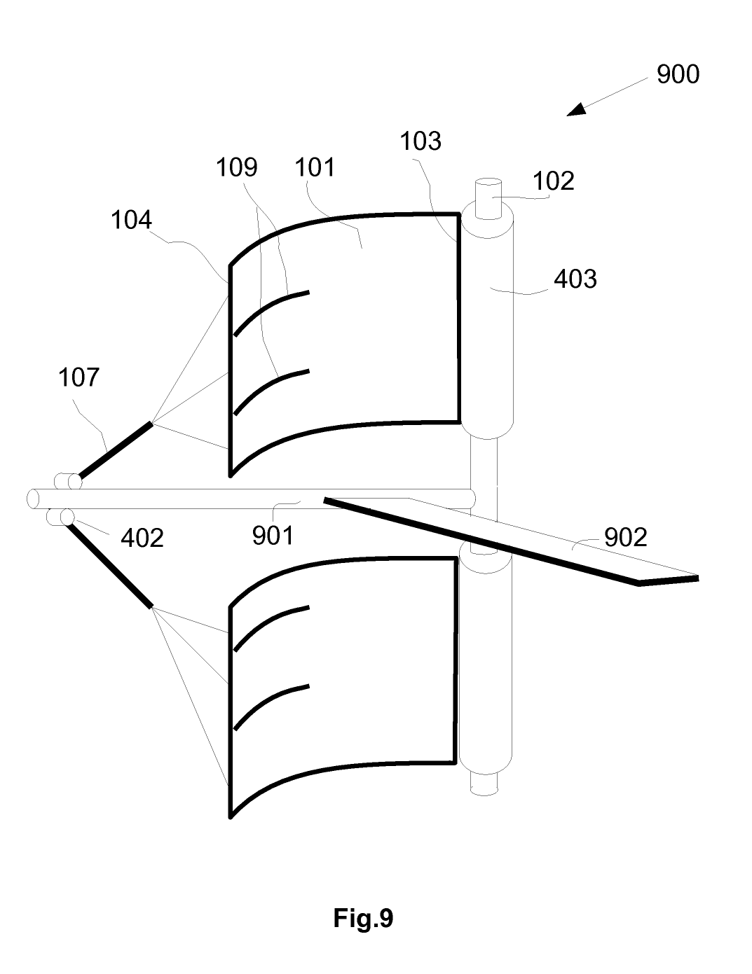

FIG. 9 shows a sail assembly 900, according to another embodiment of the invention. Soft sail 101 is attached to mast 102 with its leading edge 103. The opposite from the leading edge is trailing edge 104. The trailing edge may be reinforced with a steel wire. A pole 901 is attached to mast 102 and to an arm 902. Outhaul cable 107 connects the back end of pole 901 and trailing edge 104 of sail 101. The sail has optional battens 109, reinforcing the sail. Air flow, relative to sail 101, gives the sail airfoil form (i.e. a form that provides substantial aerodynamic lift). Further provided are actuator 402 for controlling (pulling and letting out) outhaul cable 107 and furling actuator 403 for furling and unfurling sail 101.

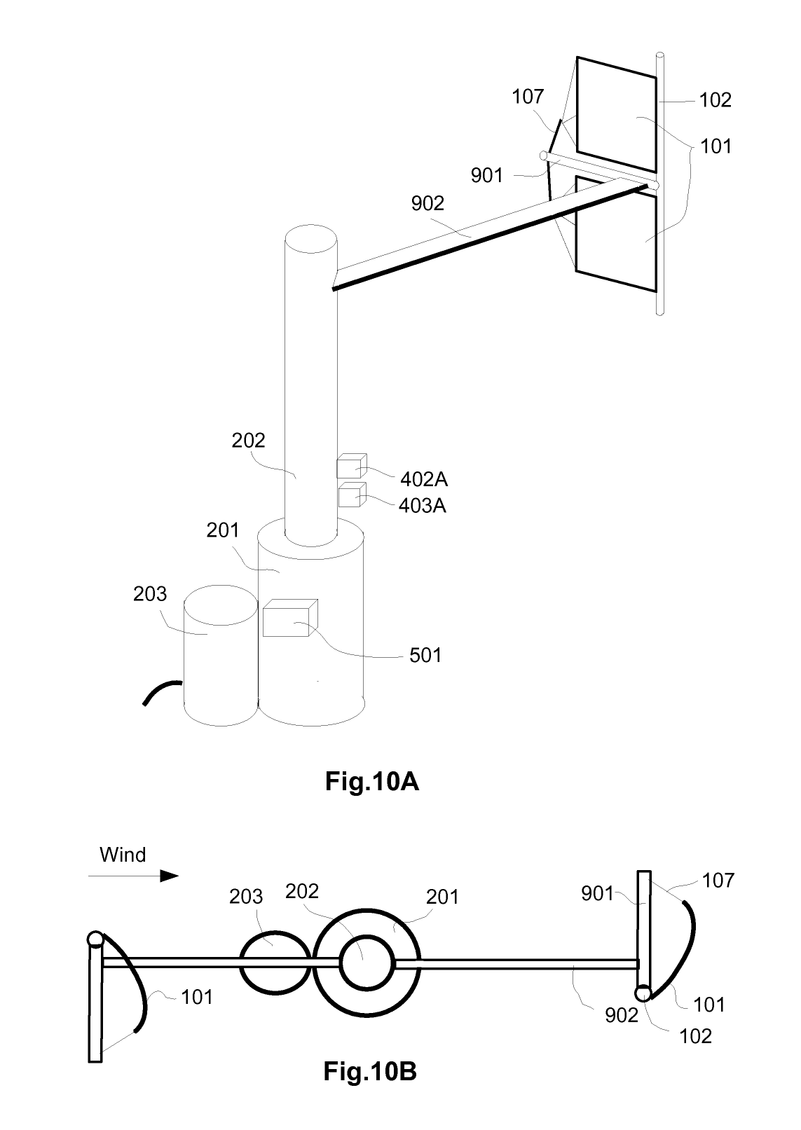

FIG. 10A and FIG. 10B show a vertical axis wind turbine according to this embodiment of the invention, using the sail assembly 900. The wind turbine comprises fixed base 201, rotating shaft 202 attached to fixed base 201 in such a way that it can freely rotate on it. Rotation of shaft 202 is transferred to the rotor of generator or alternator 203, which generates electricity. One or more arms 902 are attached to shaft 202. Each arm 902 holds sail assembly 900. Additionally, there is control system 501, managing actuator 402 and furling actuator 403. Optionally, small electrical engines 402A and 403A are attached to the shaft and drive actuator 402 and furling actuator 403 (correspondingly) via additional cables (the additional cables are not shown for clarity).

In this embodiment, the change in length of cable 107 controls the angle of attack of the airfoil and airfoil thickness in the same time. Pulling cable 107 prevents stall in both leeward and windward arcs, letting out the cable 107 increases sail power in both leeward and windward arcs.

Optionally, all or some of the control means (control system 501, actuators 402 and 403, engines 402A and 403A) can be omitted for simplicity of operation.

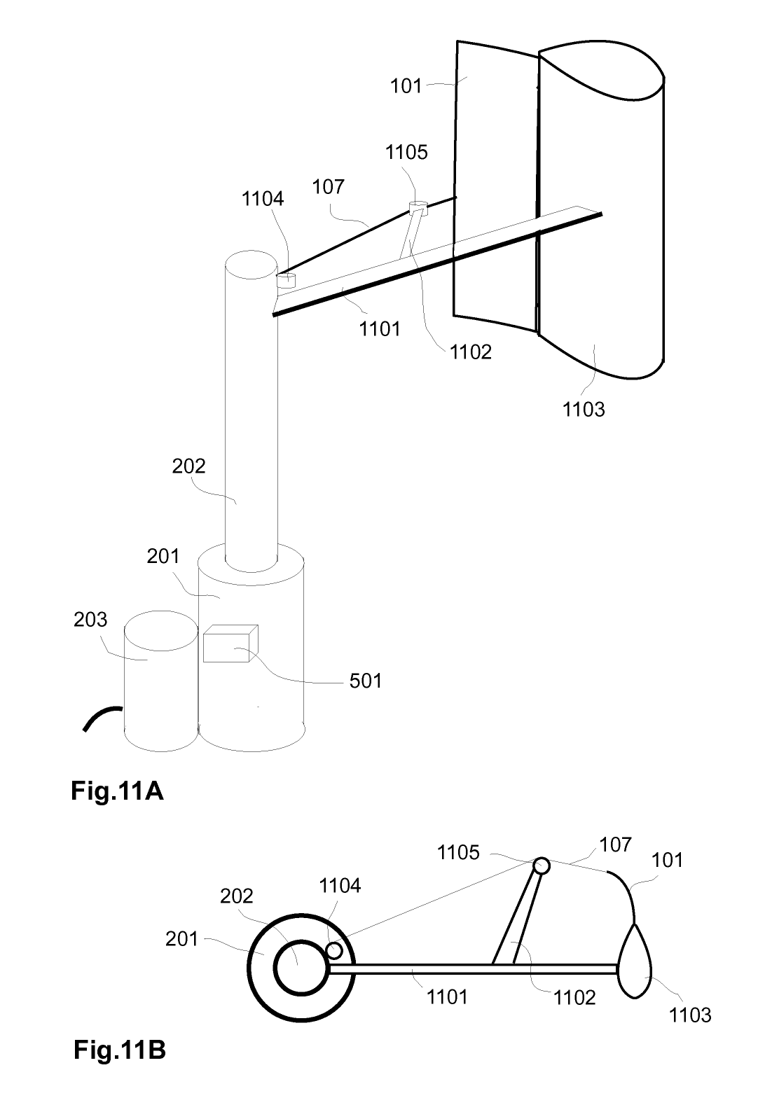

FIG. 11A and FIG. 11B show a vertical axis wind turbine according to another embodiment of the invention, having a mixed, soft-rigid wing. The wind turbine comprises fixed base 201. Rotating shaft 202 is attached to fixed base 201 in such a way that it can freely rotate on it. Rotation of shaft 202 is transferred to the rotor of generator or alternator 203, which generates electricity. One or more arms 1101 are attached to shaft 202. Each arm 1101 holds a rigid wing 1103. Sail 101 is attached to the trailing edge of rigid wing 1103. Arm 1101 hold a secondary arm 1102, which spreads main sheet cable 107, which is attached to the trailing edge of sail 101. In this embodiment soft sail 101 increases the airfoil length of rigid airfoil 1103. Optionally, there may be control system 501, attached to base 201, an actuator 1104, attached to shaft 202 and acting on main sheet cable 107 and a block 1105, allowing movement of main sheet cable 107. In this embodiment, angle of sail 101 can be controlled, and it would control the angle of attack of the mixed wing, created by soft sail 101 and rigid airfoil 1103. Further, since the rigid airfoils have large cavities inside, a mechanism can be added to hide the soft sail inside of airfoil 1103, when the winds are strong, and to pull soft sail 101 out only when the wind is weak. This will increase range of speeds in which the turbine operates, and preserve the soft sail.

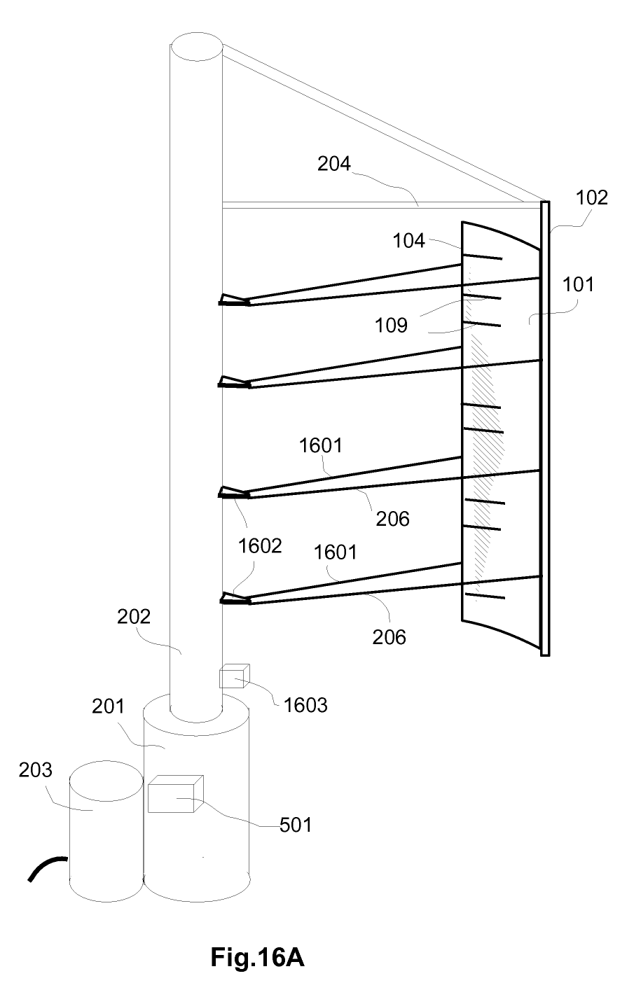

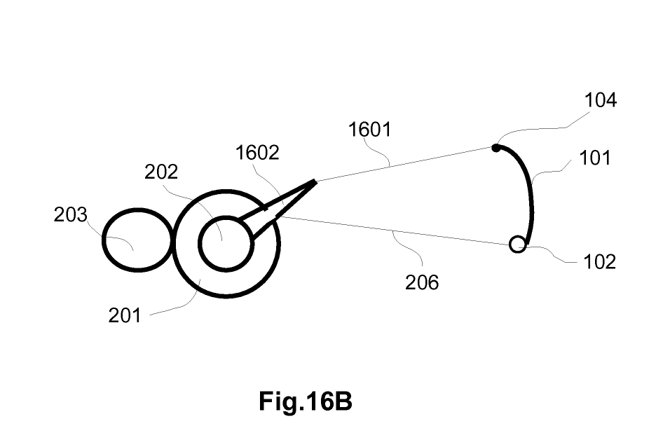

FIG. 16A and FIG. 16B show a vertical axis wind turbine according to another embodiment of the invention, not using a boom or another support structure for the trailing edge of the sail. According to this embodiment, the wind turbine comprises fixed base 201. Rotating shaft 202 is attached to fixed base 201 in such a way that it can freely rotate on it. Rotation of shaft 202 is transferred to the rotor of generator or alternator 203, which generates electricity. One or more cantilever 204 is attached to shaft 202. Each cantilever 204 holds mast 102. A leading edge of soft sail 101 is attached to mast 102, as in the previously described embodiments. One or more arms 1602 are attached to shaft 202. Cable 206 connects mast 102 and an arm 1602. Another cable 1601 connects reinforced trailing edge 104 of sail 101 to arm 1602. The length of cable 1601 is such, that trailing edge 104 of sail 101 can reach further from the shaft than mast 102. Sail 101 may have optional battens 109.

When the turbine rotates, sail 101 acquires airfoil form. Cables 206 and 1601 compensate radial component of the wind force and the centrifugal force, acting on the sail and the mast, and transfer the tangential component of the force to arm 1602, driving shaft 202. In one variation of this embodiment, the sail behaves as shown on FIG. 3: it receives airfoil form and harvests the wind energy only in the leeward arc, and it becomes flat and limp and lying in the plain of the relative wind with minimum resistance in the rest of the rotational circle.

In another variation of this embodiment, additional control system 501 and cable control means 1603 are provided, that change the length of cable 1601. Cable control means 1603 can take a form of electrical engine, pulling and releasing cable 1601. Cable 1601 in this embodiment should be longer than length of cable 206 plus length of sail 101. This would allow to remove pull on the sail's trailing edge in any position, thus letting the sail to become flat along the wind, achieving aerodynamic braking in the strong winds or on demand. In this embodiment, the diameter of the turbine, the rotational speed and the weight of the sail, and especially of its trailing edge 104 are selected in such way, that centrifugal forces, acting on the trailing edge of sail, exceed the wind forces over the whole length of the circle of rotation. In this embodiment the sail behaves as shown in FIG. 8: the sail receives airfoil form and harvests wind energy both on leeward and windward sides. The length of cable 1601 is controlled to provide optimal angle of attack in each position of the mast. For example, the cable is shortened (pulled) in the position III on FIG. 8, and lengthened in the position I.

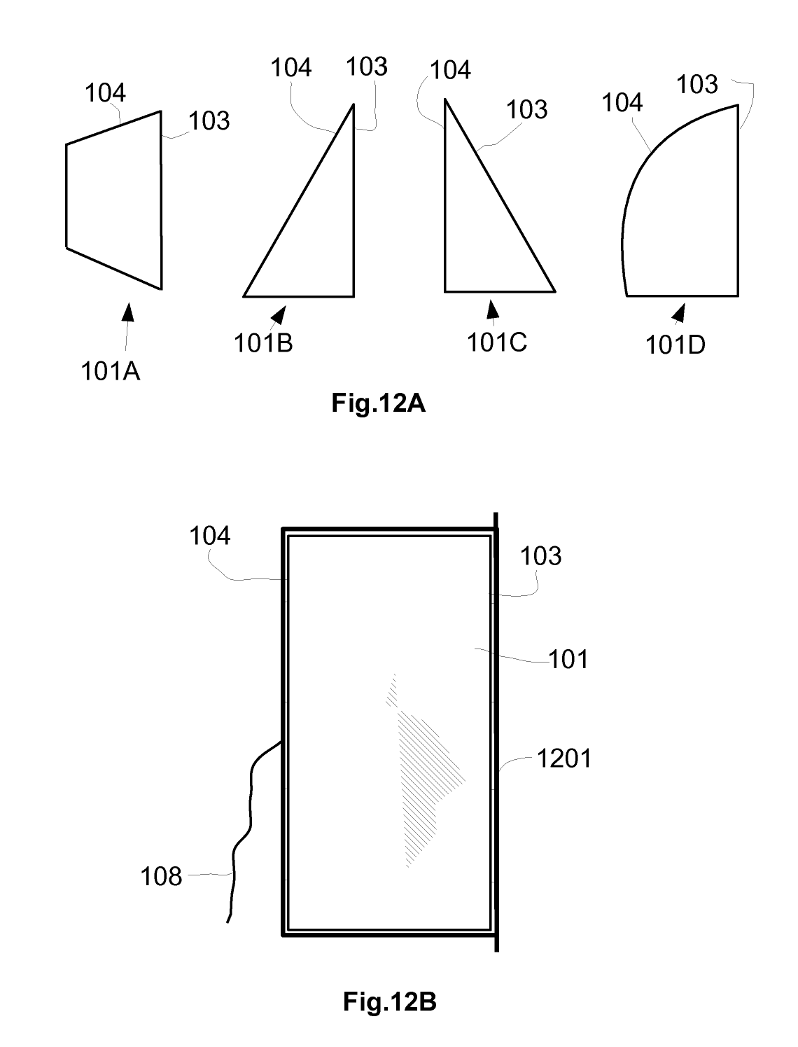

The figures, referenced above, show rectangle sails, but other forms of sails are possible as well. For example, FIG. 12A shows a trapezoid sail 101A, a triangle sail 101B, another triangle sail 101C and a curved sail 101D. Each sail has leading edge 103 and trailing edge 104. Additional forms of the supporting structures in the sail assembly are possible as well. For example, FIG. 12B shows a frame-like sail assembly, in which a rigid frame 1201 holds sail 101 (with its leading edge 103 and trailing edge 103) in such way that relative air flow gives it airfoil form, and main sheet cable 108 is attached to this rigid frame on the side of the trailing edge.

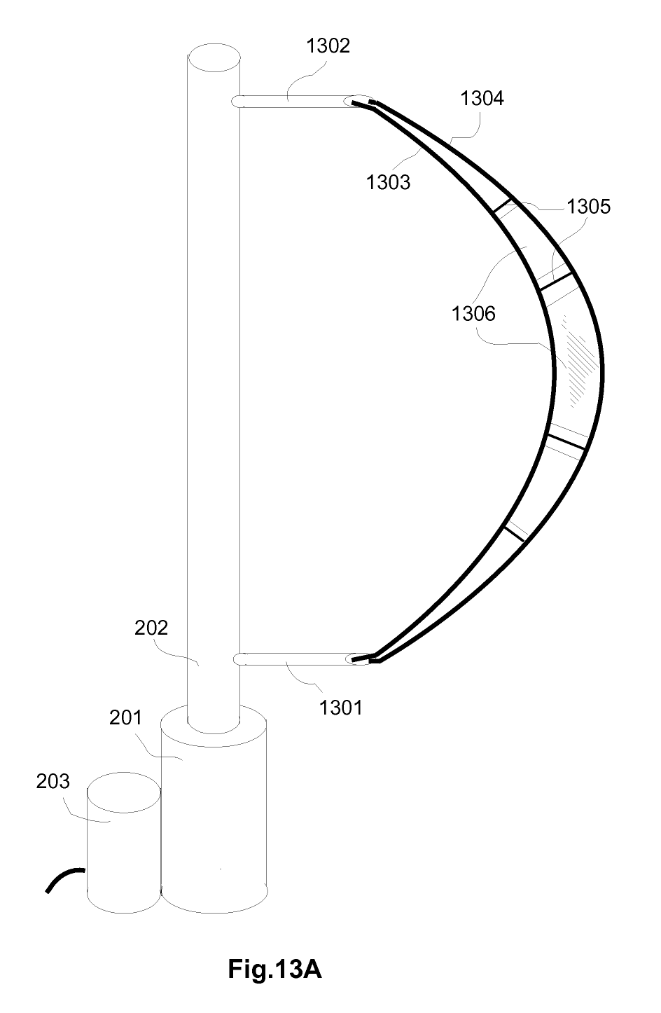

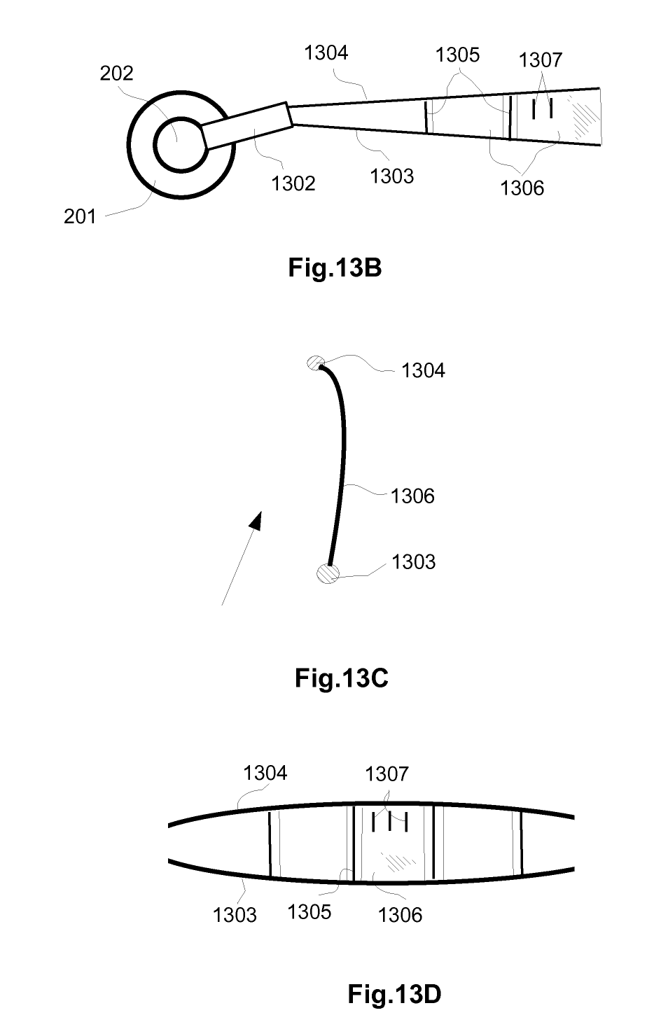

FIG. 13A and FIG. 13B show a vertical axis wind turbine according to another embodiment of the invention, in its working position (i.e., when it rotates). The figure shows the turbine, having one sail assembly and rotating clockwise, if viewed from the top. The wind turbine comprises fixed base 201. Rotating shaft 202 is attached to fixed base 201 in such a way that it can freely rotate on it. Rotation of shaft 202 is transferred to the rotor of generator or alternator 203, which generates electricity. A bottom arm 1301 and a top arm 1302 are attached to shaft 202. Two cables, a leading cable 1303 and a trailing cable 1304 are between arms 1301 and 1302. When the shaft rotates, cables 1303 and 1304 acquire form, close to troposkein, under influence of the centrifugal forces. One or more spreaders 1305 are attached between cables 1303 and 1304 to help to keep the distance between the cables. One or more soft sails 1306 are attached between cables 1303 and 1304. Soft sails 1306 might have battens 1307 for reinforcement. Soft sails 1306 become airfoils (i.e., provide aerodynamic lift) in the relative air flow, when the turbine rotor rotates.

FIG. 13C shows approximate form, acquired by the sail in the presence of the relative air flow (shown on the figure with the arrow). Usually leading cable 1303 should be stronger than trailing cable 1304. The sail assembly according to this embodiment can be removed and spread on the floor and then folded for transportation. FIG. 13D shows the sail assembly, spread on the floor.

The wind turbine according to this embodiment is not self-starting. It requires some additional means for start, such as an electric engine or a small Savonius rotor. Also, it should include a mechanism to prevent the sail assembly from fouling, when the turbine slows down and the sail assembly goes down under its weight. Preferred number of the sail assemblies in this embodiment is 2-3, although other numbers are possible. Preferred material for the cables is inexpensive steel wire, for the sails—para-aramid or polyester, for the ribs—carbon fiber, fiberglass or aluminum. Other materials are suitable.

This embodiment is extremely light weight and easy to transport and install, since the sail assembly can be folded down.

This embodiment can be modified in different ways. In one variation, leading cable 1303 is replaced with a rigid curved mast in the form of troposkein, made of fiberglass, aluminum or other material. In another variation, both leading cable 1303 and trailing cable 1304 are replaced with rigid curved masts in the form of troposkein. In yet another variation, leading cable 1303 is replaced with a rigid curved mast in the form of troposkein, having additional helical twist. Another variation has no spreaders 1305, relying on the centrifugal and wind forces to maintain distance between cables 1303 and 1304. This variation can have a single sale 101 in each sail assembly over most of its length.

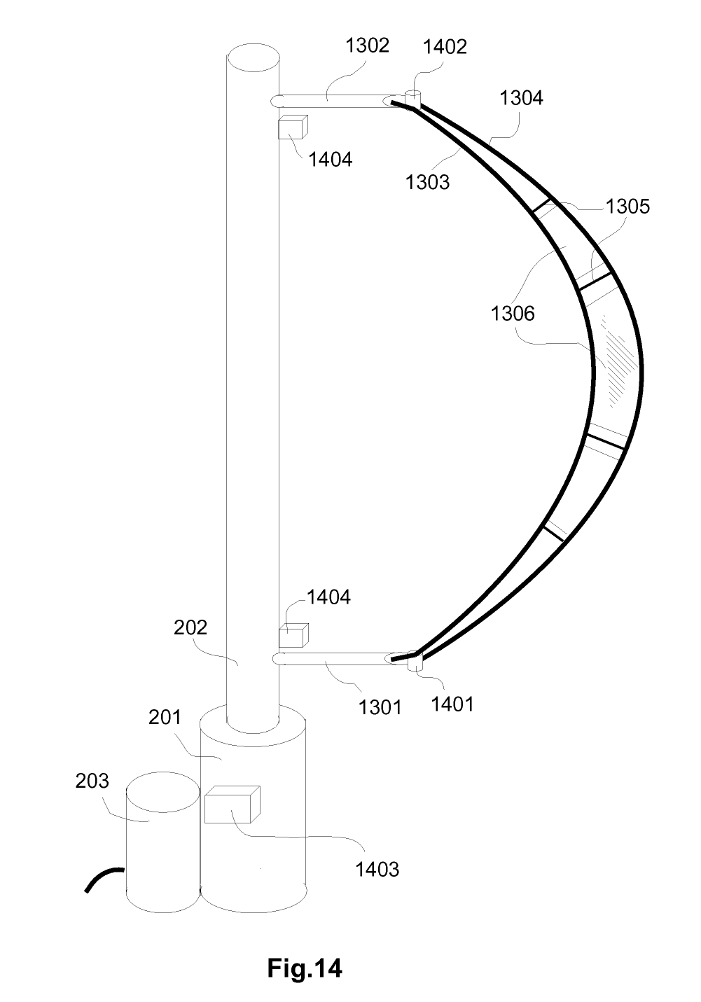

FIG. 14 shows a vertical axis wind turbine according to another embodiment of the invention. It is similar to the one, shown in the FIG. 13A-D, but contains additional control elements: a bottom trailing cable actuator 1401, a top trailing cable actuator 1402 and a control system 1403 that manages them. For actuators 1401 and 1402 an electrical motor, pulling and letting out trailing cable 1304 according to signals from control system 1403, can be used. A small electric motor 1404 can be used to drive multiple actuators 1401 and/or 1402 through additional cables (not shown).

Simultaneous pulling or letting out trailing cable 1304 by actuators 1401 and 1402 will change the angle of attack of the airfoil: pulling will decrease the angle of attack when the sail assembly is on the leeward side and increase the angle of attack when the sail assembly is on the windward side, letting out will increase the angle of attack when the sail assembly is on the leeward side and decrease the angle of attack when the sail assembly is on the windward side. This mechanism allows performing at least the following actions:
a) optimize angle of attack, based on the position of the sail assembly in the rotation cycle and the wear of the sail
b) decrease the forces, acting on the sail in the strong winds (“spill some wind”)
c) increase the forces, acting on the sail in the weak winds
d) aerodynamically brake the rotation at will by stalling the sails

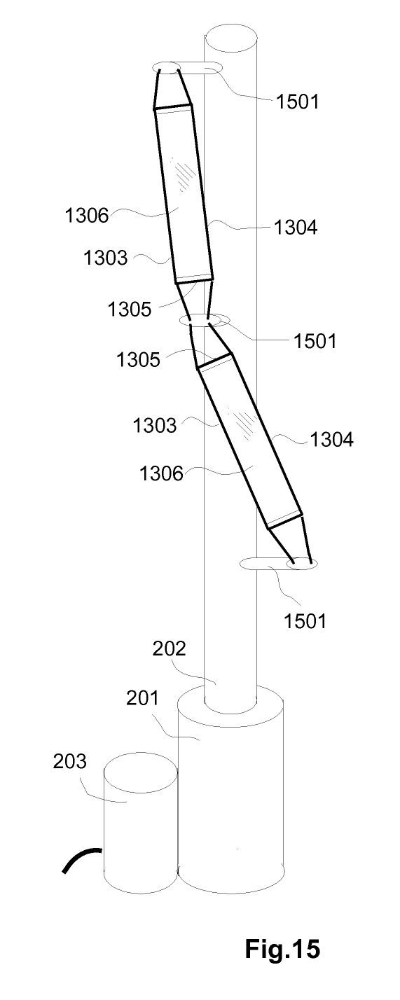

FIG. 15 shows a vertical axis wind turbine according to another embodiment of the invention. It is similar to the one, shown in the FIG. 13A-D, but contains multiple levels of sail assemblies. Moreover, arms 1501 are attached to rotating shaft 202 with non-zero angle between their projections in horizontal plane. As a result, leading cables 1303 and trailing cables 1304 are not lying in a vertical plane, but are inclined. The figure shows two levels with one sail assembly in each for clarity, but the preferred embodiment has 3 levels, each level has 3 arms at equal distance between them (i.e. there is 120 degrees between each two arms). The arms at the consecutive levels are offset by 60 degrees, and the sail assemblies are turned in a form, approximating helix. This embodiment has the advantage, that in any position the forces, acting on the turbine are approximately the same. This embodiment can be further enhanced, as described for the embodiments, shown in the FIG. 13A-D and FIG. 14.

In the embodiments, described above, the lift will be not only substantial, but the lift forces will exceed the drag forces. The sail assemblies in the embodiments, described above, can be not only vertical, but inclined in the plane of the shaft or perpendicular to it, or in both. The masts do not have to be round in section, but may have a form, that increases lift and/or decreases drag, when combined with the soft sail. The battens in the embodiments above can reinforce trailing part of the sail, or stretch all the way from the leading edge to the trailing edge. Multiple levels of sail assemblies can be stacked one top one another. The wind turbine according to the invention can be used on land or on water. Some embodiments of the invention can be used underwater as well.

Thus, a vertical axis wind turbine with soft sails is described in conjunction with one or more specific embodiments. While above description contains many specificities, these should not be construed as limitations on the scope, but rather as exemplification of several embodiments thereof. Many other variations are possible. Accordingly, the scope should be determined not by embodiments illustrated, but by the appended claims and their legal equivalents.

I claim:

1. Vertical axis wind turbine, comprising at least one soft sail, said soft sail providing substantial aerodynamic lift.
